(19) United States
(12) Patent Application Publication
(10) Pub. No.: US 2026/0335191 A1
(43) Pub. Date: Oct. 29, 2026

(54) Print Head and Cartridge for an Additive Manufacturing Device for Forming a Drug Delivery Device

(71) Applicant: Doser IP B.V., Leiden (NL)

(72) Inventors: Wouter Harm Van Unen, Leiden (NL); Thomas Willem Jan De Boer, Leiden (NL); Niels Ouwerkerk, Leiderdorp (NL)

(21) Appl. No.: 19/122,296

(22) PCT Filed: Oct. 20, 2023
(86) PCT No.: PCT/NL2023/050552

§ 371 Date: Apr. 18, 2025

(30) Foreign Application Priority Data
Oct. 20, 2022 (NL) 2033361

(51) Int. Cl. A61J 3/06; B33Y 30/00; B33Y 50/02; B33Y 80/00

(52) U.S. Cl. CPC A61J 3/06; B33Y 30/00; B33Y 50/02; B33Y 80/00

(57) ABSTRACT

Print head assembly for an additive manufacturing device for forming a drug delivery device, the print head assembly comprising:—a print head, comprising a print head housing with a receptacle for receiving at least part of a cartridge therein; and—a cartridge having an internal volume for holding a volume of drug delivery material; wherein the cartridge is provided with a level indicator providing a level signal indicative of a level of drug delivery material inside the internal volume, and wherein the print head is provided with a level signal sensor arranged for receiving the level signal of the level indicator of the cartridge.

### TECHNICAL FIELD

The aspects and embodiments thereof relate to an additive manufacturing device for forming a drug delivery device, in particular to a print head and a cartridge for said additive manufacturing device.

### BACKGROUND

At the moment, more than 50% of the medications are provided in solid dosage forms including tablets. The manufacturing of such solid dosage forms is however often complex, as it may require a plurality of ingredients and processing steps. Accordingly, it is costly and cumbersome to produce small batches. As such, the customizability of the medication is limited, and the available dosages are dictated by the suppliers. Patients and healthcare professionals may thus be restricted in their choices. Customizability of drugs has recently gained more interest as it allows for the specific adjustment of several parameters (e.g. drug concentration and release profile) to fit a patient's needs. Customized medication may be provided by additive manufacturing (also referred to as 3D printing). Additive manufacturing allows for a high level of control over several aspects, such as drug release rate, dissolution, drug concentration, shape and volume of the formulation.

WO2022086330 discloses extrusion additive manufacturing methods for forming a drug delivery device.

### SUMMARY

For medication, the weight of active pharmaceutical ingredient or ingredients administered is often critical to the effectiveness of the medication. Often, the weight of the active pharmaceutical ingredient(s) per solid dosage form, such as a pill or tablet, is in the order of milligrams. Because of this low weight of the active pharmaceutical ingredients(s), it is an object to provide for an additive manufacturing device for forming a drug delivery device with sufficient accuracy and precision in terms of weight of active pharmaceutical ingredients in the drug delivery device and/or it is an object to provide for a method of controlling such an additive manufacturing device such that a drug delivery device can be formed with sufficient accuracy and precision in terms of weight of active pharmaceutical ingredient(s) in the drug delivery device.

A first aspect of the present disclosure provides a print head assembly for an additive manufacturing device for forming a drug delivery device according to claim 1. The print head assembly allows for accurate and/or precise forming of a drug delivery device with a desired weight.

When the cartridge is provided with a level indicator providing a level signal indicative of a level of drug delivery material inside the internal volume and the print head is provided with a level signal sensor arranged for receiving the level signal of the level indicator of the cartridge, an accurate and precise determination of the weight of drug delivery material dispensed from the cartridge may be determined. The determined weight of the drug delivery material dispensed from the cartridge may correspond to the weight of drug delivery material in a formed drug delivery device, and the use of the level indicator and level signal sensor may thus allow for a precise and accurate forming of the drug delivery device.

When the level signal is obtained at two instances in time, a change in level of the level indicator may be determined. It may not be required to determine an absolute level of the level indicator. A relative level of the level indicator may be sufficient to determine the change in level of drug delivery material inside the internal volume. As such, it will be appreciated that the level signal obtained at a single instance of time may be insufficient to determine the weight of the drug delivery material dispensed from the cartridge.

In general, the level of drug delivery material inside the cartridge can be indicative of a weight of drug delivery material inside the cartridge. In examples, additional parameters such as a density of the drug delivery material and dimensions, such as one or more dimensions of the internal volume of the cartridge in which the drug delivery material is present, may be required to determine or calculate the weight of drug delivery material inside the cartridge.

A change in the level of drug delivery material inside the cartridge may hence be indicative of a change is the weight of drug delivery material still present in the cartridge. In examples, the change in the weight of drug delivery material still present in the cartridge may be sufficient to determine the weight of the drug delivery device, or at least a part thereof, which drug delivery device is at least partially formed using drug delivery material dispensed from the cartridge. Other variables from which the weight of the drug delivery material in the cartridge may depend, such as the density of the drug delivery material and the shape of the internal volume, may essentially remain constant while forming the drug delivery device.

The use of the level signal to determine the level of drug delivery material in the cartridge, and as a proxy thereof also the weight of drug delivery material in the cartridge, may be an alternative or an addition to directly measuring the weight of the drug delivery device as its being formed or after is has been formed. It has been observed that using the level signal may be more accurate, more precise, and/or allows measuring at a higher frequency compared to using a scale for measuring the weight of the drug delivery device.

As a particular option, applicable in any embodiment of a print head assembly disclosed herein, the level indicator providing the level signal and the level signal sensor may together form a non-contacting level sensor assembly. The non-contacting level sensor assembly may allow for a high frequency determination of the level of drug delivery material inside the internal volume. In particular, it has been found that the frequency with which the level of drug delivery material in the cartridge can be accurately and/or precisely determined may be higher compared to using a scale to determine the weight of the drug delivery material in the cartridge and/or the weight of the drug delivery device itself. Determining this weight directly requires a scale, and a scale inherently oscillates prior to ending in a non-moving position due to a stiffness and/or damping of the scale. The oscillation of the scale lowers the frequency at which the weight of the drug delivery material and/or drug delivery device can be determined accurately and/or precisely. It may even be required to wait a particular amount of time for the oscillation to be dampened sufficiently.

In general, for a non-contacting sensor assembly, a first part of the assembly sending a sensor signal and a second part of the assembly receiving the sensor signal do not rely on a mechanical connection, and/or any force or torque interaction between the parts. It will be understood however that the two parts may however be connected via other components.

Preferably, the level signal is a magnetic field. The print head may then comprise one or more magnetic field sensors. Preferably, the print head comprises at least one Hall effect sensor and/or Hall effect switch as the level signal sensor. Further preferably, the print head comprises a plurality of Hall effect sensors. It will be understood that embodiments of print head assemblies are envisioned wherein the print head assembly in general comprises at least one Hall effect sensor and/or Hall effect switch as the level signal sensor. Hence, the at least one Hall effect sensor and/or Hall effect switch as the level signal sensor are not necessarily comprised by a print head. Other magnetic field sensors may be used additionally or alternatively to Hall effect sensors, such as but not limited to Eddy current sensors.

When the level signal sensor is positioned adjacent to the receptacle for receiving at least part of the cartridge therein, in use when the cartridge is positioned in the receptacle, the level signal sensor may in use be adjacent to the level indicator of the cartridge. For non-contacting sensor assembly, a minimal distance between the level indicator and the level signal sensor may be required such that the level signal reaches the level signal sensor, in particular with sufficient power.

Additionally or as an alternative to using a magnetic field as a level signal, the level indicator may be arranged to receive and reflect an electromagnetic radiation signal as the level signal, and the level signal sensor is arranged to receive the reflected electromagnetic radiation signal. For example, any embodiment of the print head, or more in general any embodiment of the additive manufacturing device, may further comprise an electromagnetic radiation source, such as a laser, arranged to send the electromagnetic radiation signal to the level indicator.

For example, laser Doppler velocimetry may be used to determine a change in position of the level indicator. Alternatively or additionally, a plurality of interspaced markings may be used of which the distance between the markings in known. As the markings reflect electromagnetic radiation, such as light, different than their surroundings, by counting the number of markings passed, a distance travelled by the piston can be determined.

When the cartridge comprises a piston moveable in the internal volume of the cartridge, the level indicator may be connected to rigidly move with the piston. For example, the level indicator may be comprised by the piston, positioned inside the piston, or more in general the level indicator may be connected to the piston.

As a further option, for any embodiment of the cartridge comprising a piston, a first side of the piston may be exposed to the internal volume of the cartridge, and a second side of the piston opposite to the first side may be free of a plunger. Preferably, in use, the second side of the piston is exposed to a pressurised fluid, such as pressurised air, to force drug delivery material out of the cartridge.

An ejection outlet of the cartridge may extend beyond the print head housing when the cartridge is positioned in the receptacle of the print head housing. As such, preferably, it is prevented that drug delivery material discharged from the ejection outlet contact the print head.

In general, it may be preferred to heat the drug delivery material in the internal volume of the cartridge. In examples, conduction, convection, radiation, and/or induction heating may be used to heat the drug delivery material in the internal volume of the cartridge, in any combination thereof.

When an increased part of the receptacle is shaped as a negative of an outer shape of at least part of the cartridge, the contact area between the cartridge and the cartridge may be improved. A larger contact area between the cartridge and the print head may increase thermal conductivity. Preferably, when the cartridge is positioned in the receptacle, conductive heat transfer is allowed between the print head and at least 80% of an outer surface of the cartridge, or even more preferably between at least 90% or even at least 95% of the outer surface of the cartridge.

A second aspect provides a cartridge for a print head assembly, such as but not limited to any print head assembly according to first aspect. The cartridge comprise a cartridge housing with an internal volume for holding a volume of drug delivery material, and an ejection outlet through the cartridge housing. A piston is positioned in the internal volume, and is moveable in the internal volume, for example in a direction parallel to an elongation direction of the internal volume when the internal volume has an elongated shape.

When a level indicator is comprised by or connected to the piston, such that the level indicator moves together with the piston in the internal volume, a level signal sensor can be used to receive a level signal provided by the level indicator. As such, the level of drug delivery material in the internal volume of the cartridge can be determined and/or a change in the level of drug delivery material in the internal volume of the cartridge can be determined.

In general, for any of the aspects disclosed herein, it may only be required to determine a change in the level of drug delivery material in the internal volume of the cartridge can be determined, instead of being able to determine an absolute level of drug delivery material in the internal volume of the cartridge. However, in examples, it may also be preferred to be able to determine the absolute level of drug delivery material in the internal volume of the cartridge.

Preferably, the level indicator comprises a magnetic element. However, embodiments of cartridges of which the level indicator does not comprise a magnetic element are envisioned as well. In general, a magnetic element is arranged to produce a magnetic field. As such, for example, the level indicator may be or comprise a magnet, in particular a permanent magnet. The level indicator may hence comprise one or more ferromagnetic materials.

When the cartridge is to be used in a process of forming a drug delivery device, the internal volume of the cartridge may be at least partially filled with a drug delivery material. For example, the internal volume may be filled with between 1-100 mL, in particular between 3-50 mL or even between 5-45 mL of drug delivery material. Additionally or alternatively, the internal volume may be filled with between 1-100 grams, in particular between 3-50 grams or even between 5-45 grams of drug delivery material. Cartridges suitable for holding other volumes, such as more than 100 mL and/or other weights, such as more than 100 grams, are envisioned as well.

A third aspect provides another cartridge for an additive manufacturing device for forming a drug delivery device. Features disclosed in conjunction with any cartridge according to the third aspect may be readily applied to embodiments of any cartridge according to the second aspect, and vice versa.

According to the third aspect, a cartridge is envisioned comprising a cartridge housing with an internal volume for holding a volume of drug delivery material and an ejection outlet through the cartridge housing. The cartridge further comprises an electronic memory for carrying electronic data. As options, a cartridge according to the third aspect may comprise a piston and/or a level indicator. The electronic memory may also be comprised by a cartridge according to the second aspect, optionally together with any other optional feature of the electronic memory as disclosed herein.

Electronic data stored on an electronic memory of a cartridge may generally be indicative of one or more parameters required to determine the weight of the drug delivery material ejected from the cartridge, in particular in combination with a change in position of the piston of the cartridge.

In examples, the electronic data stored on the electronic memory of the cartridge may be indicative of a density of a drug delivery material.

Additionally or alternatively to storing electronic data indicative a density of a drug delivery material, other data may also be stored on the electronic memory of the cartridge. In general, whenever the electronic memory of the cartridge is mentioned, reference may be made to a single memory device or a plurality of memory devices. Other data may for example be indicative of printing parameters such as a preferred temperature or temperature range for the drug delivery material, a preferred pressure or pressure range for the drug delivery material, identification data indicative of a particular batch of drug delivery material, a viscosity of the drug delivery material, data indicative of the type of active pharmaceutical ingredient(s) in the drug delivery material, data indicative of a concentration of the active pharmaceutical ingredient(s) in the drug delivery material, any other parameter, or any combination thereof.

In general, it may be preferred to also allow data relating to the use of the cartridge to be written onto an electronic memory of the cartridge. For example, data relating to the use of the cartridge may be indicative of how long the cartridge has been heated, in particular how long the cartridge has been heated to a specific temperature or temperature range, the weight of drug delivery material ejected from the cartridge, any other data, or any combination thereof.

In general, as an option applicable to any cartridge disclosed herein, the cartridge housing may be formed by at least two connectable housing sections. When a cartridge housing is formed by at least two connectable housing sections, the housing section may be connected using an interference fit connection. Such a connection may allow for housing sections which are convenient to manufacture, and/or an interference fit connection may be very secure which in turn may increase the ease with which the cartridge housing can be cleaned. An interference fit connection may for example be obtained using shrink-fitting—i.e. making use of thermal expansion and subsequent cooling. Preferably, but not necessarily, housing sections are not threaded together.

As an option for cartridges according to the second aspect and according to the third aspect, the piston may comprise a piston body and two flanges extending radially outward from the piston body, which two flanges are positioned at a distance from each other. In examples, one or more flanges may be formed by one or more O-rings or piston rings. The two flanges may prevent or reduce tilting of the piston while moving in the cartridge, which tilting may otherwise prevent or inhibit movement of the piston in the cartridge.

When a piston comprises the two flanges and a magnetic element, the magnetic element may be positioned in-between the two flanges. In other examples, the magnetic element may be positioned below the two flanges—i.e. closer to the ejection outlet—or the magnetic element may be positioned above the two flanges—i.e. further away from the ejection outlet.

The cartridge housing may comprise a nozzle part of which an outer surface is tapered towards the ejection outlet. Additionally or alternatively, an inner surface of the nozzle part may be tapered towards the ejection outlet.

When the cartridge housing has a rotationally symmetric outer shape, the cartridge housing may be positioned in the receptacle in a plurality of orientations. When the cartridge housing has a rotationally asymmetric outer shape, the cartridge housing may be positioned in the receptacle in a limited number of orientations, for example in only one orientation.

A fourth aspect provides a set of cartridges for a print head assembly, for example but not limited to a print head assembly according to the first aspect. The set of cartridges comprises a first cartridge, with a first cartridge housing with a first internal volume, and a second cartridge, with a second cartridge housing with a second internal volume. When an outer shape of the first cartridge housing corresponds to an outer shape of the second cartridge housing, and a diameter of the first internal volume is smaller than a diameter of the second internal volume, the cartridges may be compatible for use with the same print head or similarly print heads.

However, the cartridge with the smaller diameter internal volume may be used for more accurate dispensing of drug delivery material as a movement of a piston through the internal volume with the smaller diameter results in less drug delivery material being discharged compared to the same movement of a piston through the internal volume with the larger diameter. In a particular example, the internal volume of both cartridges in the set of cartridges is filled with drug delivery material with one or more corresponding active pharmaceutical ingredients, albeit in different concentrations.

In particular when both cartridges in the set of cartridges comprise a level indicator providing a level signal indicative of a level of drug delivery material inside the internal volume, the weight of the cartridge itself may not be relevant for determining the weight of drug delivery material discharged from the cartridge.

A fifth aspect provides another set of cartridges for a print head assembly, for example but not limited to a print head assembly according to the first aspect. The another set of cartridges comprises a first cartridge, with a first cartridge housing with a first internal volume, and a second cartridge, with a second cartridge housing with a second internal volume. When the first internal volume is at least partially filled with a drug delivery material with a first concentration of an active pharmaceutical ingredient, and when the second internal volume is at least partially filled with a drug delivery material with a second concentration of the active pharmaceutical ingredient, different drug delivery devices may be formed using a single additive manufacturing device compatible to form drug delivery devices using a plurality of cartridges, which drug delivery devices may have different amounts of active pharmaceutical ingredients.

A difference in the amount of active pharmaceutical ingredients between two drug delivery devices may be a factor 5 or more, a factor 10 or more, or even a factor 50 or more.

It will be appreciated that different features disclosed in conjunction with the fourth aspect may be readily applied to the fifth aspect, and vice versa.

A sixth aspect provides a print head for a print head assembly, for example but not limited to a print head assembly according to the first aspect. The print head comprises a print head housing with a receptacle for receiving at least part of a cartridge therein, and a level signal sensor arranged for receiving a level signal from a level indicator positioned in the receptacle.

Preferably, but not necessarily, the level signal sensor comprises a plurality of Hall effect sensors. In general, a Hall effect sensor may be used to detect a magnetic field as a level signal. As another option, additionally or alternatively, the level signal sensor may be arranged to receive a reflected electromagnetic radiation signal, such as a beam of visible or invisible light.

A seventh aspect provides another print head for a print head assembly, for example but not limited to a print head assembly according to the first aspect. Features disclosed in conjunction with any print head according to the sixth aspect may be readily applied to any print head according to the seventh aspect, and vice versa. According to the seventh aspect, the print head comprises a memory controller for reading data from an electronic memory inside the receptacle, and for writing data on an electronic memory inside the receptacle, in particular by a contactless interaction with the electronic memory.

In general, any print head disclosed herein may have a print head housing which has an opening aligned with the receptacle through which part of a cartridge can protrude. In particular, it may be preferred that the cartridge protrudes through the opening such that an ejection nozzle of the cartridge is in use positioned outside the receptacle.

An eight aspect provides an additive manufacturing device for forming a drug delivery device. The additive manufacturing device comprises a printing bed onto which one or more drug delivery devices may be formed. The additive manufacturing device further comprises a print head, which may be any print head according to the sixth and/or seventh aspect, and at least one actuator stage for moving the print head relative to the printing bed.

When the additive manufacturing device further comprises a level signal sensor arranged for receiving a level signal of a level indicator of a cartridge positioned in the print head and/or connected to the print head, the additive manufacturing device may be controlled at least partially based on a level of drug delivery material in the cartridge and/or a change in the level of drug delivery material in the cartridge.

As a particular option, applicable in combination with any other options disclosed herein, the level signal sensor is connected to move with the print head. Preferably, but not necessarily, the level signal sensor is comprised by the print head.

In embodiments, the additive manufacturing device may comprise a plurality of print heads. For example, multiple print heads may be connected to be moved relative to the printing bed with the same actuator stage. Additionally or alternatively, one or more actuator stages may be provided per individual print head.

When a level signal shield is positioned between two print heads of the plurality of print heads, which level signal shield is arranged to dampen a level signal travelling from a cartridge in the receptacle of a first of the print heads to a level signal sensor of the second of the print heads, it may be prevented that a level signal originating from a cartridge not associated with the second of the print heads reaches a level signal sensor of the second of the print heads.

When the level signal is a magnetic field, and the second of the print heads comprises one or more Hall effect sensors and/or Hall effect switches, the level signal shield may for example be arranged to block or dampen a magnetic field, and as such prevent interference between one or more non-associated level indicators and the one or more Hall effect sensors and/or Hall effect switches.

When the level signal is a reflected electromagnetic radiation signal, the level signal shield may be arranged to dampen, block, or redirect said reflected electromagnetic radiation signal.

As a particular option, applicable to any embodiment of the additive manufacturing device disclosed herein, the printing bed is a fixed printing bed during the forming of the drug delivery device. Preferably, the printing bed does not form part of a moveable scale. Instead of using the printing bed as a scale to measure the weight of the drug delivery device during and/or after formation thereof, according to the present disclosure, a level of drug delivery material in one or more cartridges may be used to determine the weight of the drug delivery device during and/or after formation thereof.

Preferably, the additive manufacturing device is suitable for extrusion additive manufacturing, in particular semi-solid extrusion.

A ninth aspect provides a method of controlling an additive manufacturing device, for example but not limited to an additive manufacturing device according to the eight aspect, in performing an additive manufacturing process for forming a drug delivery device.

The method comprises steps of positioning a cartridge with an internal volume holding a volume of drug delivery material relative to a printing bed, ejecting a volume of drug delivery material from the cartridge onto the printing bed to form at least part of the drug delivery device, and determining a level of the drug delivery material in the internal volume of the cartridge. When the level of the drug delivery material in the internal volume of the cartridge can be determined, an ejection speed of the drug delivery material from the cartridge and/or the positioning of the cartridge relative to the printing bed may be controlled based on the determined level of the drug delivery material in the internal volume of the cartridge.

The level of the drug delivery material in the internal volume of the cartridge may in general be determined while the cartridge is moved relative to the printing bed, and/or when the cartridge is stationary. It has been observed that a more accurate and/or precise value for the level of the drug delivery material may be obtained when the cartridge is stationary, and as such the method may include one or more steps of determining the level of the drug delivery material in the internal volume of the cartridge when the cartridge is stationary.

Determining the level of the drug delivery material in the internal volume of the cartridge comprises may in general comprise receiving a level signal from a level indicator comprised by the cartridge by a level signal sensor and processing the level signal to determine the level of the drug delivery material in the internal volume of the cartridge.

As an option, the method may further comprise steps of receiving a user input indicative of a desired weight of the drug delivery device, using the determined level of the drug delivery material in the internal volume of the cartridge, determining an ejected weight of drug delivery material ejected from the cartridge, and controlling the additive manufacturing process based on desired weight of the drug delivery device and the determined ejected weight of drug delivery material ejected from the cartridge.

Preferably, the drug delivery device is formed on a stationary printing bed, preferably a printing bed which is not a moveable scale. Additionally or alternatively, the level of the drug delivery material in the internal volume of the cartridge is determined while ejecting the drug delivery material from the cartridge.

Preferably, the drug delivery material is ejected from the cartridge by means of a pressurised gas. For example, a piston of the cartridge may be exposed to the pressurised gas. Using pressurised gas may advantageously allow for accurate, precise, and/or fast control of the amount of drug delivery material ejected from the cartridge. As an alternative to using pressurised gas, for example a plunger may be used to move a piston of the cartridge.

Multiple different ways of moving the piston of the cartridge are thus envisioned, next to or as an alternative to using pressurised gas. For example, one or more of an electric, pneumatic, and/or hydraulic actuator may be used to move the piston, directly or indirectly via a plunger, in any combination thereof. For example, a rotating spindle drive may be used to move the piston. Any actuator for moving the piston may be arranged to receive an actuator control signal from a controller of the additive manufacturing device. However, compared to many other actuators, using pressurised gas may have the advantage that the pressure may be released almost instantaneously, and therefore the ejection process of ejecting drug delivery material from the cartridge may be accurately controlled. After the pressure has been released, the piston may even move upwards slightly away from the ejection opening due to elasticity of the drug delivery material.

It will be understood that different options disclosed in conjunction with the different aspects may be readily applied to other aspects than which they are explicitly mentioned with.

### BRIEF DESCRIPTION OF THE FIGURES

In the figures,

FIG. 1 shows in an isometric view an embodiment of an additive manufacturing device;

FIGS. 2A and 2B depict an embodiment of a cartridge for a print head assembly of an additive manufacturing device;

FIG. 3A shows another embodiment of a cartridge;

FIG. 3B shows a detailed view of part of the cartridge shown in FIG. 3A;

FIGS. 4A and 4B show in an isometric view an example of a print head;

FIG. 4C shows a print head assembly;

FIG. 5 shows a section view of the print head assembly of FIG. 4C; and

FIG. 6 schematically depicts a particular embodiment of an additive manufacturing device.

### DETAILED DESCRIPTION OF THE FIGURES

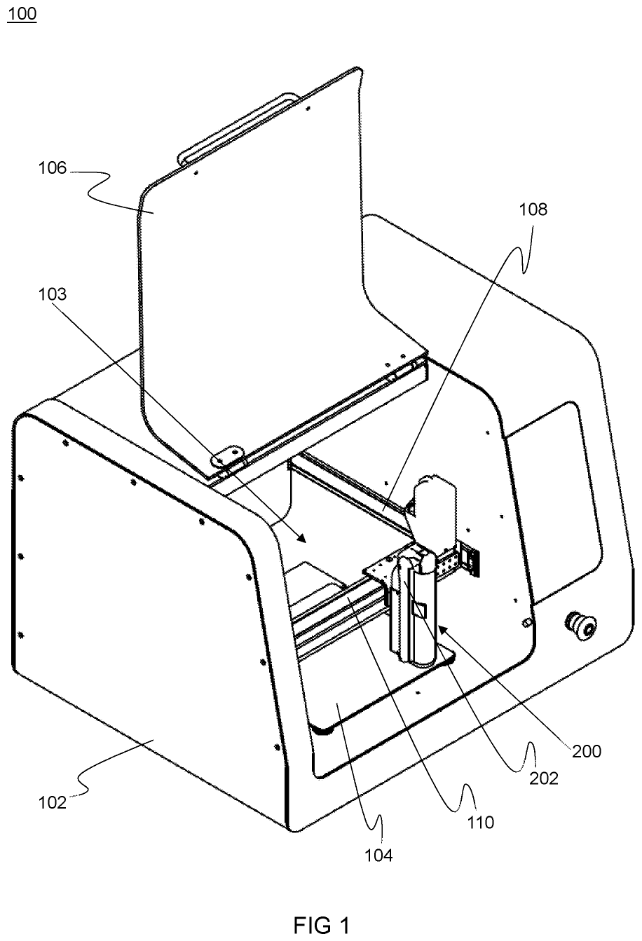

FIG. 1 shows in an isometric view an embodiment of an additive manufacturing device 100, also commonly referred to as a 3D printer. The additive manufacturing device 100 comprises an optional housing 102, which housing 102 defines a manufacturing chamber 103 therein. Access into the manufacturing chamber 103 may be restricted using a lid 106, which may be hingedly connected to the housing 102. The lid 106 in in FIG. 1 depicted in an open state. The additive manufacturing device 100 further comprises a printing bed 104 onto which one or more drug delivery devices may be formed.

The additive manufacturing device 100 comprises at least one print head assembly 200, which print head assembly 200 in turn comprises a print head 202 and at least one cartridge. The print head 202 is moveable relative to the printing bed 104. In particular, the print head 202 is connected to a first actuator stage 108 and a second actuator stage 110. The actuator stages allow the print head 202 to be moved in a generally horizontal plane, the actuator stages allowing translation of the print head 202 in perpendicular translation directions. The second actuator stage 110 is moved with the first actuator stage 108. An actuator stage may for example comprise a linear drive. Other examples of actuator stages are envisioned as well, allowing movement of the print head 202 in one or more directions relative to the printing bed 104.

Although the manufacturing device 100 is in FIG. 1 shown with a single print head 202, it will be understood that manufacturing devices 100 are envisioned comprising multiple print heads, for example two print heads, three print heads, or even four or more print heads.

Alternatively or additionally, the printing bed 104 may be moveable relative to the print head 202 using one or more actuators arranged to move the printing bed 104 relative to the print head 202.

Preferably, when the manufacturing device 100 comprises the housing 102, the printing bed 104 is fixed to the housing 102. Alternatively, for example when the manufacturing device 100 comprises an open device frame instead of the housing 102, the printing bed 104 is fixed to said frame. Further alternatively, the printing bed 104 may be fixed to another object, such as a table, external frame, or another fixed world. It will hence be understood that it may be preferred to rigidly connect the printing bed 104 to the fixed world—i.e. without significant stiffness and/or damping, for example a stiffness and/or damping typically associated with a scale used for measuring a mass of a drug delivery device formed on the printing bed 104. Using a level sensor assembly for determining a level of drug delivery material inside a cartridge may alleviate the need of using a scale.

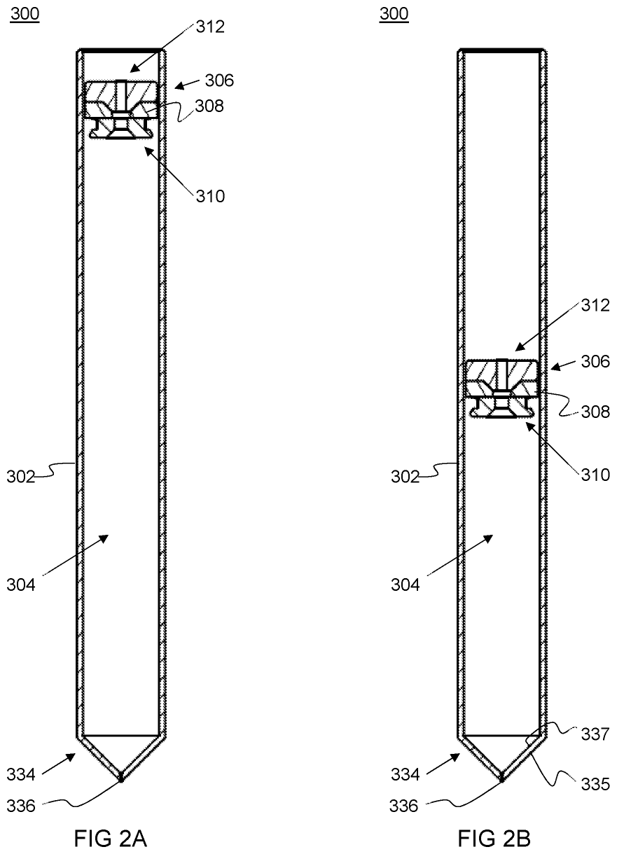

FIGS. 2A and 2B depict an embodiment of a cartridge 300 for a print head assembly of an additive manufacturing device, for example the device 100 of FIG. 1. The cartridge 300 is depicted in a section view. The cartridge 300 comprises a cartridge housing 302. Between FIG. 2A and FIG. 2B, the piston 306 of the cartridge 300 has moved through the internal volume 304 of the cartridge towards an ejection outlet 336 through the cartridge housing 302. As the piston 306 moves towards the ejection outlet 336, drug delivery material in the internal volume 304 may be ejected from the cartridge 300 to form at least part of a drug delivery device. It will be appreciated that the cartridges 300 depicted in the figures are shown without drug delivery material for clarity of the figures.

As a particular option depicted in FIGS. 2A and 2B, but applicable to any embodiment of the cartridge 300 disclose herein, part of the cartridge housing 302 is tapered towards the ejection outlet 336. For example, the cartridge housing 302 may comprise a nozzle part 334 of which an outer surface 335 is tapered towards the ejection outlet 336. Additionally or alternatively, an inner surface 337 of at least part of the nozzle part 334 may be tapered towards the ejection outlet 336. Apart from the nozzle part 334, the cartridge housing 302 may have a cylindrical shape.

As depicted in FIGS. 2A and 2B, a first side 310 of the piston 306 may be exposed to the internal volume 304 of the cartridge and/or may be facing towards the ejection outlet 336. A second side 312 of the piston 306, opposite to the first side 310, may face away from the ejection outlet 336. Preferably, but not necessarily, the second side 312 of the piston 306 is not connected to a further component such as a plunger. The second side 312 of the piston 306 may in used be exposed to a pressurised fluid, such as a pressurised gas, used to force the piston 306 towards the ejection outlet 336 and thereby ejecting drug delivery material from the cartridge 300.

In general, a level indicator 308 is connected to rigidly move with the piston 306. The level indicator 308 can form part of the piston 306 itself, or may be a separate component connected to the piston 306. The level indicator 308 may for example be positioned in-between the first side 310 of the piston and the second side 312 of the piston.

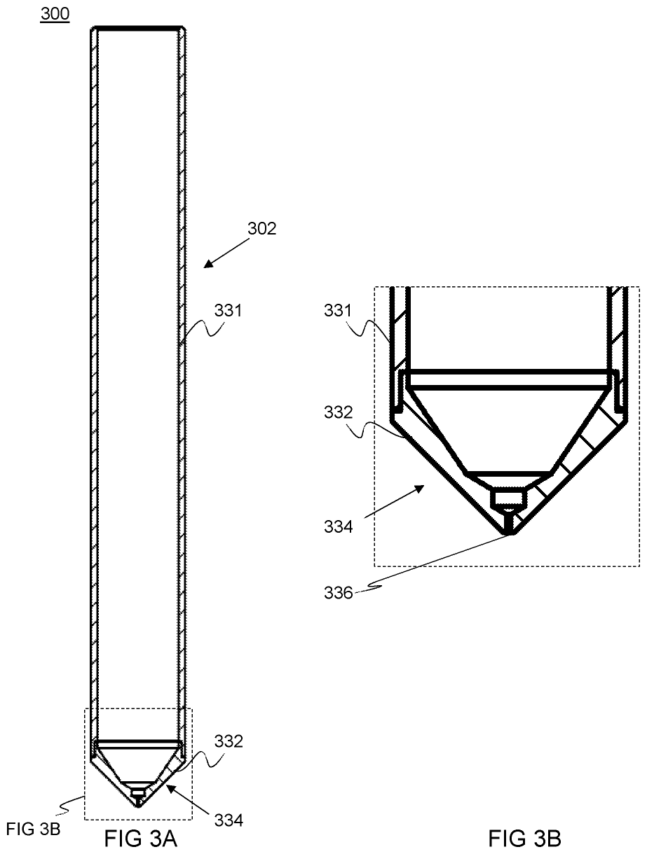

FIG. 3A shows another embodiment of a cartridge 300, with a particular option that the cartridge housing 302 is formed by two connected housing sections 331, 332, which can be a lower section 332 and an upper section 331. As a further option, the second housing section 332 may form the nozzle part 334 of the cartridge 300. The upper section 331 may for example have a cylindrical shape, although other shapes are envisioned as well for the upper section 331.

FIG. 3B shows a detailed view of part of the cartridge 300 shown in FIG. 3A, focussed on the nozzle part 334. The lower section 332 is preferably connected with an interference fit to the upper section 331. Although in FIG. 3B the lower section 332 is positioned partially inside the upper section 331, it is also envisioned that part of the upper section 331 can be positioned in the lower section 332.

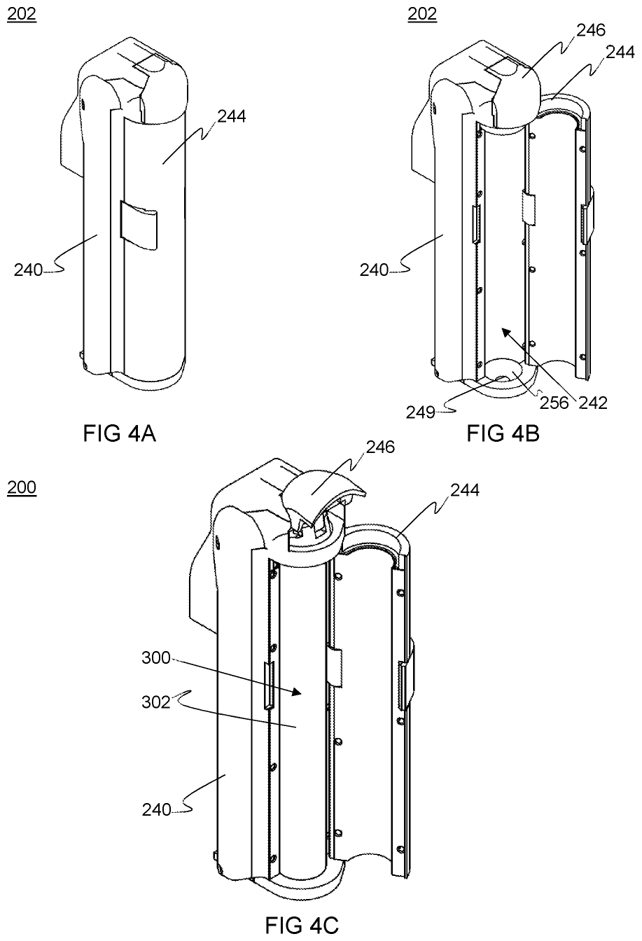

FIGS. 4A and 4B show in an isometric view an example of a print head 202 which may be comprised by any additive manufacturing device 100 disclosed herein. The print head 202 comprises a print head housing 240 defining at least part of a receptacle 242 for receiving at least part of a cartridge therein. FIG. 4C shows a print head assembly 200 with the print head 202 and a cartridge 300 positioned in the receptacle 242.

As a preferred option, depicted in FIGS. 4A-4C, the print head 202 comprises a lid 244 arranged to provide or restrict access into the receptacle 242. In FIG. 4A, the lid 244 is shown in a closed state, thereby restricting access into the receptacle 242. In FIGS. 4B-4C, the lid 244 is shown in an opened state, thereby allowing access into the receptacle 242, for example for positioning a cartridge 300 into the receptacle 242, or removing a cartridge 300 from the receptacle 242. The lid 244 may be connected to be hinged relative to the print head housing 240, in particular around a rotation axis generally parallel to an elongation direction of the receptacle 242.

Preferably, the print head 202 comprises one or more heaters (not depicted in the figures) for heating a cartridge 300 positioned in the receptacle 242. Further preferably, but not necessarily, heating the cartridge 300 is done through conduction, for example by conductive heat transfer between the print head housing 240 and the cartridge housing 302. As such, contact between the print head housing 240 and the cartridge housing 302 may be required, and a contact surface area between the print head housing 240 and the cartridge housing 302 is preferably optimised. To increase contact area between the print head housing 240 and the cartridge housing 302 and/or to provide for more homogenous heating of the cartridge housing 302, also conductive heat transfer from the lid 242 to the cartridge housing 302 is preferred.

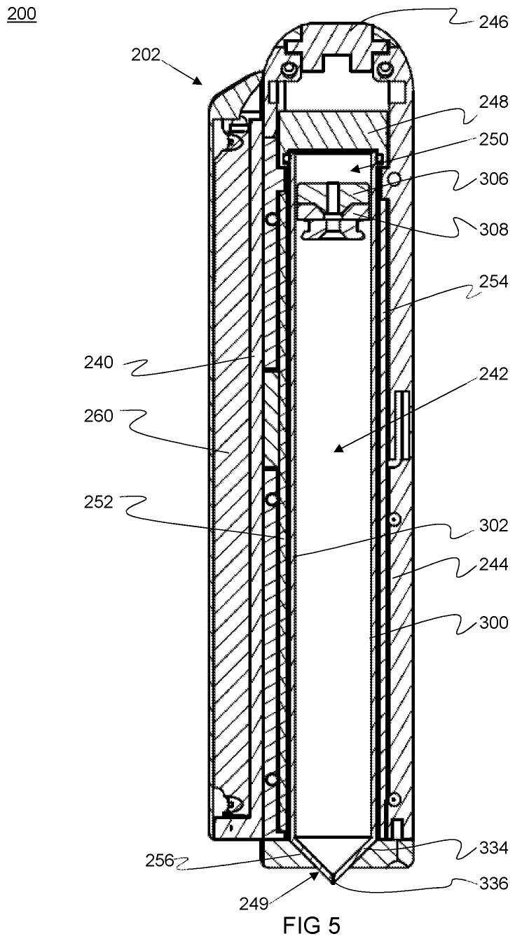

A further option, which as with all other options may be applied to any embodiment of the print head 202, the print head 202 may further comprise a locking member 246 arranged to fixate a position and/or orientation of the cartridge 300 in the receptacle 300. FIGS. 4A and 4B shown the locking member 246 in a locking state, and in FIG. 4C the locking member 246 is shown in a released state in which it does not fixate the cartridge 300 to allow the cartridge 300 to be removed from the print head 202, for example after the cartridge 300 has been at least partially emptied. Additionally, moving the locking member 246 in the locking state may be used to form an air-tight chamber 250 above the piston 306 of the cartridge 300—as will be elaborated on in conjunction with FIG. 5.

FIG. 5 shows a section view of the print head assembly 200 of FIG. 4C, albeit with the lid 242 closed and the locking member 246 in the locking state. In the print head assembly 200 of FIG. 5, the cartridge 300 is positioned in the receptacle 242 of the print head 202. As an option depicted in FIG. 5, part of the cartridge 300 can protrude out of the print head 202. In particular, it is preferred that the ejection outlet 336 is positioned outside of the receptacle 242, and even further preferably outside out of the entire print head 202 such that drug delivery material ejected from the cartridge 300 in use cannot accidentally contact the print head 202.

A magnetic element 308 is connected to move with the piston 306 of the cartridge 300 shown in FIG. 5, and magnetic element 308 is as such an example of a level indicator. The magnetic element 308 creates a magnetic field, which is used as a level signal. The print head 202 comprises a level signal sensor 260 arranged for receiving the magnetic field of the magnetic element 308. To this end, the level signal sensor 260 is positioned adjacent to the receptacle 242, and thus in use adjacent to the cartridge 300.

To move the piston 306 towards the ejection outlet 336, or in other words, to expel drug delivery material from the cartridge 300, pressurised gas such as pressurised air may be used. In particular, in use an air chamber 250 may be formed by the print head assembly 200. The air chamber 250 is delimited by the piston 306, and a such the piston 306 can at one side be exposed to the pressurised gas. The air chamber 250 may further be delimited by a sealing member 248 of the print head 202. Optionally, but not necessarily, the sealing member 248 may be connected to move together with the locking member 246 of the print head 202. As such, for example, when the locking member 246 is moved into the locking position, the sealing member 248 forms an essentially air-tight seal with the cartridge 300 such that the air chamber 250 is formed. One or more gas inlets and/or one or more gas outlets may allow pressurised gas to enter and/or exit the air chamber 250. One or more elastic elements, such as one or more springs, may be used to force the sealing member 248 onto the cartridge 300. The sealing member 248 itself may additionally or alternatively be at least partially elastically deformed when the essentially air-tight seal is formed with the cartridge 300.

As an even further option, depicted in FIG. 5 but applicable to any embodiment of the print head 202 and/or print head assembly 200 disclosed herein, the print head 202 may comprise one or more heating elements 252, 254. In general, a heating element may be used to increase the temperature of drug delivery material in a cartridge 300 positioned in the receptacle of the print head 202. In FIG. 5, a first heating element 252 is positioned between the receptacle 242 and the print head housing 240, and an optional second heating element 254 is positioned between the lid 244 and the receptacle 242.

When conductive heating is used to heat drug delivery material in the cartridge 300, for example by heating the cartridge housing 302, it may be preferred to optimise the contact area between the cartridge housing 302 and the heating element(s), and optionally any further components positioned in-between the cartridge housing 302 and the heating element(s) through which thermal energy can be transferred.

As an option depicted in FIG. 5, the print head housing 240 may have an opening 249 through which part of the cartridge 300 can protrude. It particular, a part of the cartridge housing 302 forming the ejection outlet 336 can protrude from the print head housing 240. When the ejection outlet 336 is formed in a nozzle part 334, at least part of the nozzle part 334 can protrude out of the opening 249. In general, when the cartridge housing 302 has a tapered nozzle part 334, part of the receptacle 242 may be formed by a tapered inner wall 256 of the print head housing 240. The tapered nozzle part 334 and tapered inner wall 256 may be used to properly position and/or orientate the cartridge 300 in the receptacle, as the tapered nozzle part 334 and tapered inner wall 256 may form a self-centring mechanism.

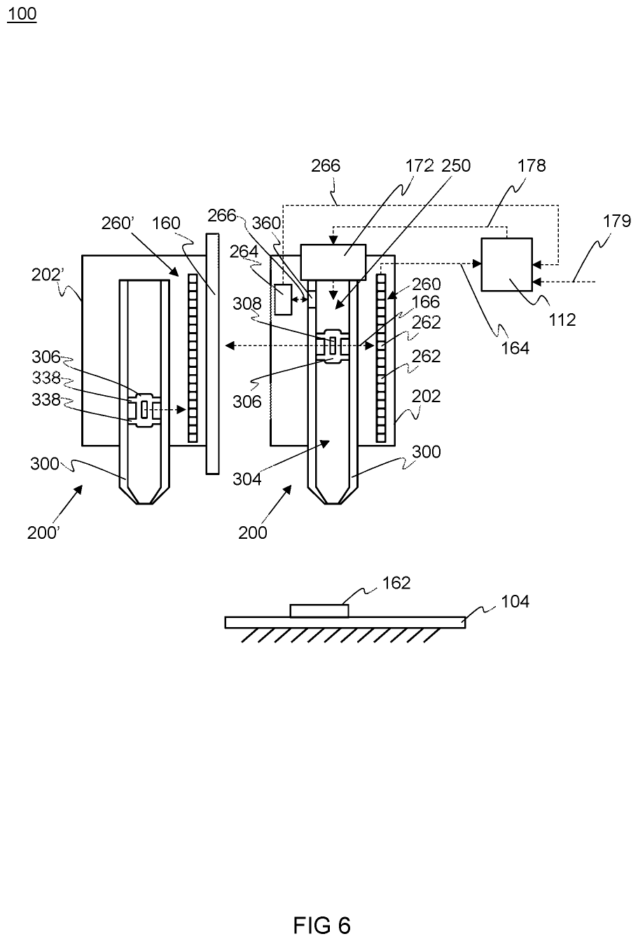

FIG. 6 schematically depicts a particular embodiment of an additive manufacturing device 100. As a particular option, the additive manufacturing device 100 is depicted comprising two print head assemblies 200, 200′, each comprising a print head 202 and a cartridge 300. It will be understood that the second print head assembly 200′ is an optional feature.

The additive manufacturing device 100 is in FIG. 6 depicted comprising a controller 112. The controller 112 may in general however be comprised by any additive manufacturing device 100 disclosed herein. The controller 112 is generally arranged to perform one or more or all steps of a method of controlling an additive manufacturing device in performing an additive manufacturing process for forming a drug delivery device. In examples, the controller 112 may not be comprised by the additive manufacturing device itself, but may be a general controller 112 arranged to control at least parts of the additive manufacturing device. The controller 112 generally comprises one or more electronic processing units to perform one or more tasks. The controller 112 may as an option be comprised by the print head 202. When the additive manufacturing device comprises one or more heating elements, as for example comprised by a print head, the controller 112 may be arranged to control said one or more heating elements.

As a further option applicable to any other embodiment of the additive manufacturing device 100, FIG. 6 shows the additive manufacturing device 100 comprising a pressurised gas source 172 arranged to provide a pressurised gas to the cartridge 300, in particular to a volume 250 at an opposite side of the piston 306 as the drug delivery material. The pressurised gas source 172 is an example of an ejection actuator.

The print head 202 comprises a sensor array 260 as a level signal sensor, comprising a plurality of Hall effect sensors 262, of which for conciseness of the figure only two are provided with a reference numeral. In use, the plurality of Hall effect sensors 262 may be stacked in a generally vertical direction, or at least in a direction parallel to a movement direction of the level indicator 308 and/or the piston 306 of the cartridge 300. Additionally or alternatively to using Hall effect sensors, Hall effect switches may be generally used. Generally, it will be understood that instead of or additionally to using Hall effect sensors and/or Hall effect switches, one or more other sensors for detecting a magnetic field may be used.

The controller 112 is arranged to receive level data 164 from the sensor array 260 indicative of the level of drug delivery material inside the cartridge 300. The sensor array 260 is in turn arranged to receive the level signal 166 from the level indicator 308. As the piston 306 is moved through the internal volume 304 of the cartridge 300, the level indicator 308 preferably moves together with the piston 306. When the level signal 166 for example is a magnetic field, this magnetic field thus moves together with the piston 306 and is picked up by one or more different Hall effect sensors 262 as the piston 306 moves.

The level data 164 can be used by the controller 112 to control an ejection speed of ejecting drug delivery material from the cartridge 300 and/or for positioning the cartridge 300 relative to the printing bed 104. The controller 112 can thus be arranged to control one or more actuator stages comprised by the additive manufacturing device 100 (not shown in FIG. 6) and/or an ejection actuator, such as the pressurised gas source 172, for ejecting drug delivery material from the cartridge 300. The controller 112 may thus generate and send an ejection actuator control signal 178 to the pressurised gas source 172 as indicated in FIG. 6.

In order to determine a weight of drug delivery material ejected from the cartridge, the determined level of the drug delivery material in the internal volume of the cartridge can be used. However, one or more additional parameters such as data indicative of a density of the drug delivery material inside the cartridge 300 may be required to determine the weight of drug delivery material ejected from the cartridge. These one or more additional parameters may be stored on an optional electronic memory 360 comprised by the cartridge.

When the cartridge 300 comprises an electronic memory 360, the print head 202 or more in general the additive manufacturing device 100 may comprise a memory controller 264 for reading data from an electronic memory inside the receptacle, and preferably also for writing data on an electronic memory inside the receptacle. As such, data 266 at least indicative of a density of the drug delivery material in the cartridge 300 may be supplied to the controller 112 via the memory controller 264. The data 266 may additionally or alternatively be indicative of one or more dimensions, such as a diameter, of the internal volume 304 of the cartridge 300.

Although not indicated in FIG. 6, the memory controller 264 may further be used for writing data to the electronic memory 360. Such data may for example be indicative of the use of the cartridge 300, and may comprise any parameter as disclosed herein, in any combination.

As an option shown in FIG. 6, but applicable for any embodiment of the cartridge 300 disclosed herein, the piston 306 of any cartridge may comprise two flanges 338 extending radially outward from the piston, which two flanges 338 are positioned at a distance from each other.

When embodiments of the additive manufacturing device 100 comprise a plurality of print heads 200, a level signal shield 160 may be positioned between two print heads of the plurality of print heads-as schematically depicted in FIG. 6. The level signal shield 160 is arranged to dampen the level signal 166 travelling from the cartridge 300 in the receptacle of the right print head 200 to a level signal sensor 260′ of the left print head 200′. Dampening the level signal generally prevents significant the level signal 166 associated with the right print head 200 to affect the level signal sensor 260′ of the left print head 200.

When the additive manufacturing device 100 comprises a controller 112, the controller 112 may be arranged for receiving a user input 179 indicative of a desired weight of the drug delivery device 162. The controller 112 may then control the additive manufacturing process based on the desired weight of the drug delivery device and a determined ejected weight of drug delivery material ejected from the cartridge. Preferably, the ejected weight is determined using the level sensor assembly comprising the level indicator 308 and the level signal sensor 260.

In the description above, it will be understood that when an element is referred to as being connect to another element, the element is either directly connected to the other element, or intervening elements may also be present. Also, it will be understood that the values given in the description above, are given by way of example and that other values may be possible and/or may be strived for.

It is to be noted that the figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features or steps. Furthermore, the words ‘a’ and ‘an’ shall not be construed as limited to ‘only one’, but instead are used to mean ‘at least one’, and do not exclude a plurality.

1. A print head assembly for an additive manufacturing device for forming a drug delivery device, the print head assembly comprising:
a print head, comprising a print head housing with a receptacle for receiving at least part of a cartridge therein; and
a cartridge having an internal volume for holding a volume of drug delivery material;
wherein the cartridge is provided with a level indicator providing a level signal indicative of a level of drug delivery material inside the internal volume,
and wherein the print head is provided with a level signal sensor arranged for receiving the level signal of the level indicator of the cartridge.

2. The print head assembly according to claim 1, wherein the level indicator providing the level signal and the level signal sensor together form a non-contacting level sensor assembly.

3. The print head assembly according to claim 1, wherein the level signal is a magnetic field.

4. The print head assembly according to claim 3, wherein the print head comprises at least one Hall effect sensor and/or Hall effect switch as the level signal sensor.

5. The print head assembly according to claim 1, wherein the level signal sensor is positioned adjacent to the receptacle.

6. The print head assembly according to claim 1, wherein the level indicator is arranged to receive and reflect an electromagnetic radiation signal as the level signal, and the level signal sensor is arranged to receive the reflected electromagnetic radiation signal.

7. The print head assembly according to claim 1, wherein the cartridge comprises a piston moveable in the internal volume of the cartridge, and the level indicator is connected to rigidly move with the piston.

8. The print head assembly according to claim 7, wherein a first side of the piston is exposed to or faces the internal volume of the cartridge, and a second side of the piston opposite to the first side is free of a plunger.

9.-10. (canceled)

11. The print head assembly according to claim 1, wherein the cartridge comprises:
a cartridge housing with an internal volume for holding a volume of drug delivery material and an ejection outlet through the cartridge housing; and
a piston, positioned in the internal volume and moveable in the internal volume;
wherein a level indicator is comprised by or connected to the piston, such that the level indicator moves together with the piston and wherein the internal volume is at least partially filled with a drug delivery material.

12.-13. (canceled)

14. The print head assembly according to claim 1, wherein the cartridge further comprises an electronic memory for carrying electronic data, wherein the electronic data is indicative of a density of a drug delivery material and/or one or more dimensions, such as a diameter, of the internal volume of the cartridge.

15.-27. (canceled)

28. The print head assembly according to claim 1, wherein the print head comprises:
a memory controller for reading data from an electronic memory inside the receptacle, and for writing data on an electronic memory inside the receptacle.

29. (canceled)

30. An additive manufacturing device for forming a drug delivery device, the additive manufacturing device comprising:
a printing bed;
a print head; and
at least one actuator stage for moving the print head relative to the printing bed;
wherein the additive manufacturing device further comprises a level signal sensor arranged for receiving a level signal of a level indicator of a cartridge positioned in and/or connected to the print head.

31. The additive manufacturing device according to claim 30, wherein the level signal sensor is connected to move with the print head.

32. (canceled)

33. The additive manufacturing device according to claim 30, comprising a plurality of print heads, and further comprising a level signal shield positioned between two print heads of the plurality of print heads, which level signal shield is arranged to dampen a level signal travelling from a cartridge in the receptacle of a first print head of the plurality of print heads to a level signal sensor of the second print head of the plurality of print heads.

34. (canceled)

35. The additive manufacturing device according to the claim 30, wherein the printing bed is a fixed printing bed during the forming of the drug delivery device.

36. (canceled)

37. A method of controlling an additive manufacturing device in performing an additive manufacturing process for forming a drug delivery device, the method comprising:
positioning a cartridge with an internal volume holding a volume of drug delivery material relative to a printing bed;
ejecting a volume of drug delivery material from the cartridge onto the printing bed to form at least part of the drug delivery device; and
determining a level of the drug delivery material in the internal volume of the cartridge; wherein an ejection speed of the drug delivery material from the cartridge and/or the positioning of the cartridge relative to the printing bed is controlled based on the determined level of the drug delivery material in the internal volume of the cartridge.

38. The method according to claim 37, wherein determining the level of the drug delivery material in the internal volume of the cartridge comprises receiving a level signal, by a level signal sensor, from a level indicator comprised by the cartridge and processing the level signal to determine the level of the drug delivery material in the internal volume of the cartridge.

39. (canceled)

40. The method according to claim 37, wherein the drug delivery device is formed on a stationary printing bed, which printing bed is not a moveable scale.

41.-43. (canceled)
